(19) United States
(12) Patent Application Publication
(10) Pub. No.: US 2006/0101860 A1
(43) Pub. Date: May 18, 2006

(54) Core insert for a glass molding machine

(75) Inventor: Ga-Lane Chen, Fremont, CA (US)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI Precision Industry CO., LTD., Tu-Cheng City (TW)

(21) Appl. No.: 11/229,249

(22) Filed: Sep. 16, 2005

(30) Foreign Application Priority Data
Nov. 12, 2004 (CN) 200410052270.3

(51) Int. Cl. C03B 11/08

(52) U.S. Cl. 65/374.11

(57) ABSTRACT

A core insert (1, 2) for a glass molding machine includes a substrate (10), an adhesive layer (20), and a protective film (30). The adhesive layer (20) is formed on a surface of the substrate (10), and the protective film (30) is formed on a surface of the adhesive layer (20). The substrate (10) is made of silicon carbide (SiC). The adhesive layer (20) is made of silicon nitride (SiₓN_{y}) or aluminum nitride (AlN). The protective film (30) is made of a material selected from the group consisting of an alloy of platinum (Pt) and iridium (Ir), an alloy of palladium (Pd) and iridium (Ir), an alloy of platinum (Pt) and rhenium (Re), and an alloy of palladium (Pd) and rhenium (Re).

### BACKGROUND OF THE INVENTION

1. Field of the Invention

The present invention generally relates to glass molding machines and, more particularly, to a core insert for a glass molding machine.

2. Discussion of the Related Art

Currently, digital camera modules are included as a feature in a wide variety of portable electronic devices. Most portable electronic devices are becoming progressively more miniaturized over time, and digital camera modules are correspondingly becoming smaller and smaller. Nevertheless, in spite of the small size of a contemporary digital camera module, consumers still demand excellent imaging. The image quality of a digital camera is mainly dependent upon the optical elements of the digital camera module.

Aspheric lenses are very important elements in the digital camera module. An aspheric lens can easily focus an image on an imaging point because the aspheric lens can attain different reflective indexes via the selection of different materials and/or profiles. Therefore an aspheric lens can avoid many of the image-forming problems of spherical lenses. In addition, with a single aspheric lens, the number of lens pieces in the camera can be reduced. Thus, the cameras can have a reduced size. Two or more aspheric lenses are used in some cameras for high quality image forming. Contemporary aspheric lenses are made of plastic or glass. Plastic aspheric lenses are generally manufactured by way of injection molding. Though the cost of plastic aspheric lenses is relatively low, the plastic aspheric lens has a low image-forming quality compared to a glass aspheric lens. This difference in quality is because the transparency of the plastic is lower than that of glass.

Glass aspheric lenses are generally manufactured by way of glass molding. The glass molding machine operates at a high temperature and high pressure during the glass molding process. Therefore, core inserts are needed, and such inserts must be accurately designed and manufactured. The core inserts should have excellent chemical stability in order not to react with the glass material. In addition, the core inserts also should have a sufficient hardness, enough rigidity, and excellent mechanical strength in order not to be scratched (or at least not readily so). Furthermore, the core inserts should be impact-resistant at high temperatures and high pressures. Moreover, the core inserts must have excellent machinability, in order for them to be machined precisely and easily to form the desired optical surfaces. Finally, the core inserts must have a long working lifetime so that the cost of manufacturing aspheric lenses is reduced.

A typical core insert comprises a substrate and a protective film. The substrate is advantageously made of stainless steel, silicon carbide (SiC), or tungsten carbide (WC). The protective film is made of a diamond-like carbon film (DLC) or noble metals. The diamond-like carbon film has a short working lifetime. The noble metals, meanwhile, have good chemical stability, rigidity, and heat-resistance. Nevertheless, the protective film made of noble metals tends to have poor adhesion with the substrate. Thus, the core insert generally has a short working lifetime, which escalates the cost of producing aspheric lenses. The cost of such core inserts using noble metals for the protective film is further magnified when considering the price of most noble metals.

What is needed is a core insert for a glass molding machine which has a long working lifetime.

### SUMMARY OF THE INVENTION

A core insert for a glass molding machine includes a substrate, an adhesive layer, and a protective film. The adhesive layer is formed on a surface of the substrate, and the protective film is formed on a surface of the adhesive layer. The substrate is made of silicon carbide (SiC). The adhesive layer is made of silicon nitride (SiₓN_{y}) and/or aluminum nitride (AlN). The protective film is made of a material selected from the group consisting of an alloy of platinum (Pt) and iridium (Ir), an alloy of palladium (Pd) and iridium (Ir), an alloy of platinum (Pt) and rhenium (Re), and an alloy of palladium (Pd) and rhenium (Re). The core insert has good adhesion between the substrate and the protective film because the adhesive layer has good adhesion with the silicon carbide (SiC) material. Therefore, the core insert has a long working lifetime.

Other objects, advantages and novel features of the core insert will become more apparent from the following detailed description when taken in conjunction with the accompanying drawings.

### BRIEF DESCRIPTION OF THE DRAWINGS

Many aspects of the core insert can be better understood with reference to the following drawings. The components in the drawings are not necessarily to scale, the emphasis instead being placed upon clearly illustrating the principles of the present core insert. Moreover, in the drawings, like reference numerals designate corresponding parts throughout the several views.

FIG. 1 is a schematic view of a core insert, in accordance with a preferred embodiment.

### DETAILED DESCRIPTION OF THE EMBODIMENTS

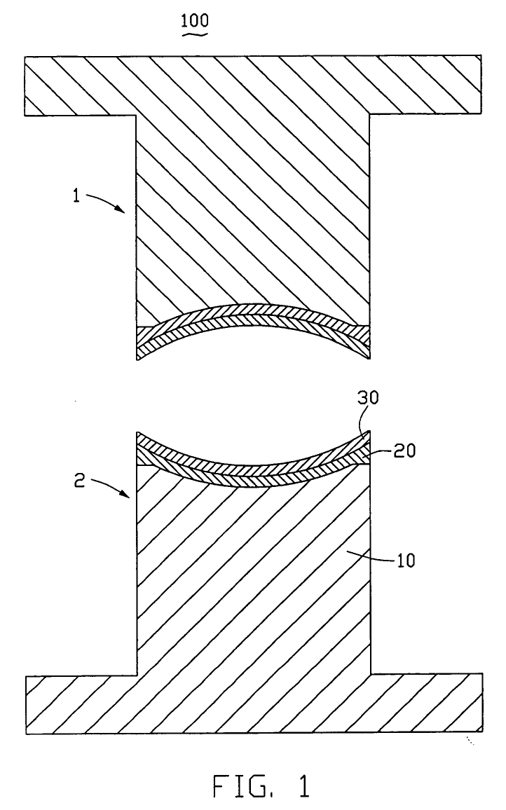

Referring to FIG. 1, a core insert system 100 of a preferred embodiment includes an upper core insert 1 and a lower core insert 2. The lower core insert 2 includes a substrate 10, an adhesive layer 20, and a protective film 30. The upper core insert 1 has the same configuration as the lower core insert 2.

The substrate 10 is advantageously made of silicon carbide (SiC), which has a high rigidity, or, alternatively, is made of material or composite composed substantially of SiC. The adhesive layer 20 is usefully made of silicon nitride (SiₓN_{y}), aluminum nitride (AlN), or a material or composite composed substantially of at least one of such nitrides. The adhesive layer 20 has a preferred thickness about in the range of 1-5 nanometers.

The protective film 30 is advantageously made of a noble metal alloy. Most advantageously, the noble metal alloy is a material selected from the group consisting of alloy of platinum (Pt) and iridium (Ir), alloy of palladium (Pd) and iridium (Ir), alloy of platinum (Pt) and rhenium (Re), and alloy of palladium (Pd) and rhenium (Re). In each alloy, the two noble metals advantageously have substantially and, more preferably, essentially the same proportion by mole. The protective film 30 usefully has a thickness in the approximate range of 100-1000 nanometer, the thickness being more preferred about in the range of 200-500 nanometer.

The materials of silicon nitride (SiₓN_{y}) and aluminum nitride (AlN) each have good adhesion both with silicon carbide (SiC) and the noble metal alloys. As such the present insert system 100 is generally able to overcome the problem of poor adhesion exhibited by the noble metal protective films, as displayed in prior art inserts. Therefore, the present core inserts 1, 2 have a good stability when operated at a high temperature and a high pressure during the glass molding process. Accordingly, the core inserts 1 and 2 can obtain a long working lifetime.

The adhesive layer 20 and the protective film 30 can be deposited, for example, by a method of vacuum vapor deposition, such as chemical vapor deposition, physical vapor deposition, and sputtering.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A core insert for a glass molding machine, comprising:
a substrate comprised of silicon carbide;
an adhesive layer comprised of at least one of silicon nitride (SiₓN_{y}) and aluminum nitride, the adhesive layer being formed on the substrate; and
a protective film made of a noble metal alloy, the protective film being formed on the adhesive layer.

2. The core insert as claimed in claim 1, wherein the noble metal alloy is one of an alloy of platinum (Pt) and iridium (Ir), an alloy of palladium (Pd) and iridium (Ir), an alloy of platinum (Pt) and rhenium (Re), and an alloy of palladium (Pd) and rhenium (Re).

3. The core insert as claimed in claim 2, wherein the proportion by mole of the noble metals in the noble metal alloy is essentially 1:1.

4. The core insert as claimed in claim 1, wherein the adhesive layer has a thickness about in the range of 1-5 nanometer.

5. The core insert as claimed in claim 1, wherein the protective film has an approximate thickness in the range of 100-1000 nanometer.

6. The core insert as claimed in claim 5, wherein the protective film has a thickness about in the range of 200-500 nanometer.

7. The core insert as claimed in claim 1, wherein the adhesive layer and the protective film are deposited by a method of vacuum vapor deposition.

8. The core insert as claimed in claim 1, wherein the adhesive layer consists essentially of at least one of silicon nitride (SiₓN_{y}) and aluminum nitride.
